(19) United States
(12) Patent Application Publication
(10) Pub. No.: US 2021/0354894 A1
(43) Pub. Date: Nov. 18, 2021

(54) Recyclable Packaging Laminate Having A Good Barrier Effect And Low Density, And Method For The Production Thereof

(71) Applicant: Constantia Pirk GmbH & Co. KG, Pirk (DE)

(72) Inventors: Thami Lamtigui, München (DE); Achim Grefenstein, Altrip (DE)

(21) Appl. No.: 17/287,653

(22) PCT Filed: Nov. 15, 2018
(86) PCT No.: PCT/EP2018/081477

§ 371 Date: Apr. 22, 2021

(51) Int. Cl. B65D 65/40; B29C 48/00; B29C 48/08; B29C 48/21; B32B 27/08; B32B 27/20; B32B 27/32; B32B 37/14

(52) U.S. Cl. CPC B65D 65/40; B29K 2995/0097; B29C 48/08; B29C 48/21; B32B 27/08; B32B 27/205; B32B 27/32; B32B 37/144; B29C 48/022; B32B 2307/7244; B32B 2307/7265; B32B 2307/732; B32B 2439/06; B32B 2307/31; B29K 2023/06; B29K 2995/0067; B29K 2995/0017; B29K 2995/0069; B29C 48/0018

(57) ABSTRACT

A recyclable, easily tearable packaging laminate having a good barrier effect and low density, including a first laminate layer and a second laminate layer. The first laminate layer is a co-extruded, stretched composite consisting of a cavitated substrate layer having 5-30 wt. % cavitating agent and a PE proportion of at least 60 wt. %, a connecting layer and a barrier layer consisting of a barrier polymer, preferably polyamide or ethylene vinyl alcohol copolymer, with a thickness of at most 20% of the overall thickness of the first laminate layer. The connecting layer is arranged between the substrate layer and the barrier layer, and the first laminate layer is connected by its barrier layer to the second laminate layer.

### TECHNICAL FIELD

The present teaching relates to a packaging laminate comprising a first laminate layer and a second laminate layer, the first laminate layer comprising a barrier layer, and to a method for producing a packaging laminate of this kind.

### BACKGROUND

In the packaging industry, packaging laminates are used which are intended to have different properties depending on their application. Such packaging laminates are usually multilayer plastics films produced by means of an extrusion process, co-extrusion process (in both cases either a flat film process or blown film process) or lamination process (connection of individual layers by means of a laminating adhesive), or combinations of these processes. Layers not consisting of plastics material can also be integrated in the packaging laminate, for example a layer of aluminum or paper. The packaging laminate usually also has an outer sealing layer so as to process the packaging laminate, by means of heat sealing, such that a desired form of packaging, e.g., a sachet, a pouch, a bag, etc., is formed.

A typical requirement for a packaging laminate is a barrier function against water vapor, oxygen, and aroma. For this purpose, the packaging laminate usually contains a barrier layer consisting of aluminum or a suitable barrier polymer, such as ethylene vinyl alcohol copolymer (EVOH) or polyamide (PA). In addition, further layers can also be contained to give the packaging laminate the desired properties, such as toughness, rigidity, shrinkability, tear resistance, etc. A sealing layer is typically made of a polyolefin, usually polypropylene (PP) or polyethylene (PE) with the various densities LLDPE, LDPE, MDPE or HDPE.

In order for it to be possible to process the packaging laminate easily, the packaging laminate obviously also must not warp or curl, and therefore symmetrical layer structures are usually used.

It is also known to change the properties of the packaging laminate by means of uniaxial or biaxial orientation. Such an orientation can be achieved by the extrusion process, for example in a multiple bubble process, or after the extrusion process has been carried out, by stretching the packaging laminate in the machine direction (in the longitudinal direction of the packaging laminate) and/or in the transverse direction (normal to the longitudinal direction). Above all, the orientation of the packaging laminate can improve rigidity, tensile strength, and toughness. Furthermore, the crystallization of the packaging laminate can be changed by the orientation such that even materials that are intrinsically somewhat cloudy, such as HDPE, are more transparent after stretching.

WO 2013/032932 A1 describes a packaging laminate of this kind, for example having the structure HDPE/connecting layer/EVOH/connecting layer/sealing layer, as a shrink film. In order to create the shrinkage property, the packaging laminate is biaxially stretched as a whole. Therefore, the stretching can only be carried out, however, once the individual layers of the packaging laminate have achieved a sufficient bond strength. The subject matter of WO 2009/017588 A1 is similar. However, WO 2013/032932 A1 and WO 2009/017588 A1 are primarily aimed at a suitable material for the connecting layer.

Films made from so-called cavitated polyolefins, in particular polypropylene, are also known. To produce such films, a cavitating agent is added to the polyolefin used before extrusion. After extrusion, the film is stretched (in the machine direction and/or transverse direction), as a result of which the embedded cavitating agent forms the microcavities in the film. Cavitated PP-based films have good rigidity and low water permeability (a high barrier to water/water vapor), but poor oxygen and aroma permeability (low oxygen and aroma barriers).

US 2012/0135256 A1 describes a packaging laminate consisting of a first laminate layer made of ethylene vinyl alcohol copolymer (EVOH) and a second laminate layer made of a cavitated PP or a mixture of cavitated PP and HDPE (high-density polyethylene). The two laminate layers are coextruded and are stretched in the machine direction and in the transverse direction after extrusion.

### SUMMARY

It is an object of the present teaching to provide a recyclable packaging laminate with a low density and yet a high barrier against water, oxygen, and aroma. Another object is to provide a method for producing a packaging laminate of this kind.

This object is achieved by co-extruding a first laminate layer consisting of a substrate layer having 5-30 wt. % cavitating agent and having a PE proportion of at least 60 wt. %, a connecting layer and a barrier layer consisting of a barrier polymer, preferably polyamide or ethylene vinyl alcohol copolymer, having a thickness of at most 20% of the overall thickness of the first laminate layer, wherein the connecting layer is arranged between the substrate layer and the barrier layer, by subsequently stretching the co-extruded first laminate layer, and by subsequently connecting the first laminate layer stretched in this manner to a second laminate layer having a polyethylene proportion of at least 80 wt. %, wherein the second laminate layer is connected to the barrier layer of the first laminate layer. The packaging laminate according to the present teaching comprises a first laminate layer and a second laminate layer, wherein the first laminate layer is a co-extruded and stretched composite consisting of a cavitated substrate layer having 5-30 wt. % of cavitating agent and having a PE proportion of at least 60 vol. %, a connecting layer and a barrier layer consisting of a barrier polymer, preferably polyamide or ethylene vinyl alcohol copolymer, with a thickness of at most 20% of the overall thickness of the first laminate layer, wherein the connecting layer is arranged between the substrate layer and the barrier layer, and the first laminate layer is connected, by its barrier layer, to the second laminate layer.

As a result of the first laminate layer being stretched before being laminated with the second laminate layer, the barrier effect of the first laminate layer is significantly increased. In addition, the simple asymmetrical structure of the first laminate layer simplifies production to a considerable extent by comparison with conventional symmetrical structures, which also significantly reduces production costs. Furthermore, the cavitating agent can reduce the density of the cavitated layer, as a result of which the weight per unit area of the packaging laminate can be reduced. In this way, very light and also thin-walled packaging can be produced without having to compromise on the barrier properties.

By metallizing or coating with aluminum oxide or silicon oxide and/or additional barrier varnishes on the barrier layer before further lamination, the barrier effect can additionally be increased.

For certain applications, it is advantageous for the first laminate layer to be connected, at the substrate layer, to a further single- or multilayer laminate layer. The first laminate layer can be printed, metallized or coated on the barrier layer and/or on the substrate layer. Likewise, at least one layer of the further laminate layer can be printed, metallized, or coated.

For certain applications, it is advantageous for the first laminate layer to be connected, at its substrate layer, to a unidirectionally (in the machine direction) or bidirectionally stretched fourth laminate layer, which has a substrate layer having a PE proportion of at least 60 wt. %, a barrier layer consisting of a barrier polymer, and a connecting layer arranged therebetween. A packaging laminate of this kind has particularly good barrier properties.

A further advantageous embodiment is obtained if the second laminate layer is a co-extruded laminate stretched in the machine direction or bidirectionally and consisting of a cavitated substrate layer having a PE proportion of at least 60 wt. %, preferably at least 70 wt. % and very particularly preferably at least 80 wt. %, a connecting layer, a barrier layer consisting of a barrier polymer, preferably polyamide or ethylene vinyl alcohol copolymer, having a thickness of at most 20% of the overall thickness of the second laminate layer, and a sealing layer, wherein the connecting layer of the second laminate layer is arranged between the substrate layer and the barrier layer of the second laminate layer and the sealing layer is arranged on the substrate layer, and the barrier layer of the second laminate layer is connected to the barrier layer of the first laminate layer. A packaging laminate of this kind also has particularly good barrier properties. In addition, the sealing layer is advantageously integrated in the co-extruded second laminate layer, and therefore no further production steps are required for the packaging laminate.

The stretched second laminate layer preferably also has a polyethylene layer having a cavitating agent, as a result of which the weight per unit area of the packaging laminate can be reduced even further. In this embodiment, it is particularly advantageous if the second laminate layer has a polyethylene layer having a cavitating agent, which is connected on one or both sides to a polyethylene layer without a cavitating agent.

### BRIEF DESCRIPTION OF THE DRAWINGS

The present teaching is described in greater detail below with reference to FIGS. 1 to 4, which show schematic and non-limiting advantageous embodiments of the present teaching by way of example. In the drawings

FIG. 1 shows a first embodiment of a packaging laminate according to the present teaching,

FIG. 2 shows a second advantageous embodiment of a packaging laminate according to the present teaching,

FIG. 3 shows a third advantageous embodiment of a packaging laminate according to the present teaching, and

FIG. 4 shows a fourth advantageous embodiment of a packaging laminate according to the present teaching.

### DETAILED DESCRIPTION

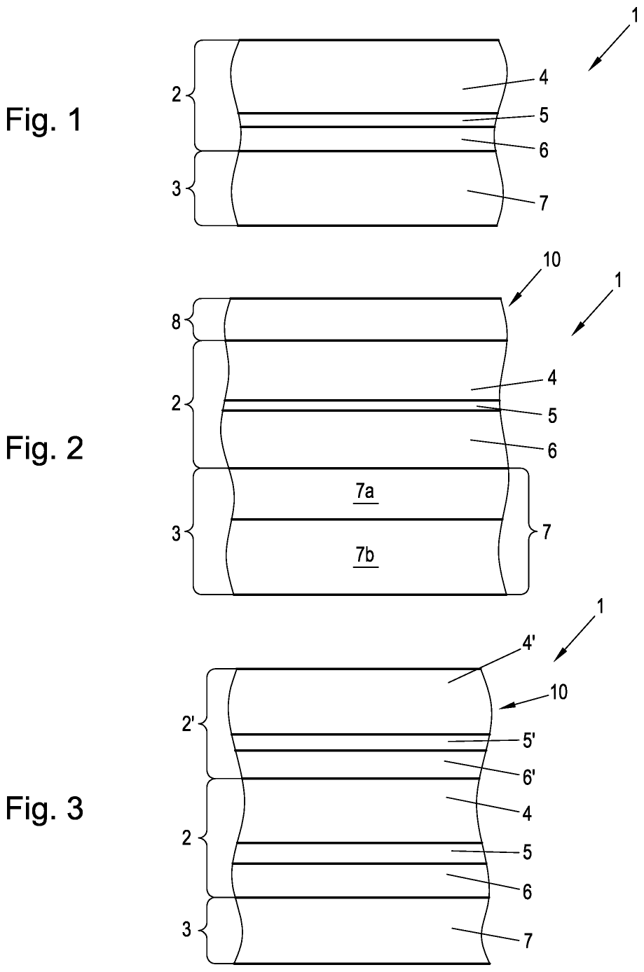

FIG. 1 shows a packaging laminate 1 according to the present teaching, comprising a first laminate layer 2 and a second laminate layer 3 connected thereto.

The first laminate layer 2 in the packaging laminate 1 is stretched in the machine direction (MDO) and/or in the transverse direction (TDO), i.e., unidirectionally (in MDO) or bidirectionally, and has an asymmetrical layer structure comprising a substrate layer 4 and a barrier layer 6 interconnected by a connecting layer 5. The thickness of the first laminate layer 2 is preferably 10 to 40 μm.

The substrate layer 4 is a polyethylene (PE), whereby different types of polyethylene can be used, such as HDPE (high-density polyethylene with a density between 0.94-0.97 g/cm³), MDPE (medium-density polyethylene), LDPE (low-density polyethylene with a density between 0.915-0.935 g/cm³), LLDPE (linear low-density polyethylene with a density between 0.87-0.94 g/cm³) or mLLDPE (linear metallocene polyethylene with low density). The use of HDPE or MDPE is preferred. Conventional additives (such as slip additives, antiblock additives, fillers, etc.) can be added to the substrate layer 4. Various types of polyethylene can also be used in the substrate layer 4, as a mixture or as a coextrudate. The substrate layer 4 can likewise comprise a compatible polyolefin material. In principle, any type of polyethylene is suitable as a compatible polyolefin material, in particular including ethylene copolymers, such as ethylene vinyl acetate copolymer (EVA), ethyl methacrylate (EMA), ethylene/acrylic acid copolymer (EAA) or ethylene butyl acrylate copolymer (EBA). Polypropylene (PP) or a cyclic olefin copolymer (COC) can also be used as a compatible polyolefin material in an amount of no more than 20 wt. %. In the case of PP, a polypropylene random copolymer with ethylene as comonomer (usually 5 to 15%), a polypropylene copolymer with ethylene or a polypropylene homopolymer that is sufficiently compatible with linear PE types, such as mLLDPE, LLDPE or HDPE, is preferably used in order to achieve at least limited recyclability. If compatible polyolefin materials are included, the proportion of polyethylene (PE) in the substrate layer is preferably at least 60 wt. %, preferably at least 70 wt. % and most preferably at least 80 wt. %, in order to improve the recyclability.

The PE and the compatible polyolefin material can be present in the substrate layer 4 as a mixture. The substrate layer 4 can, however, also have a multilayer structure (extruded or co-extruded) comprising one (or more) PE layer(s) and one (or more) layer of the compatible polyolefin material.

The thickness of the substrate layer 4 is preferably 5 to 35 μm.

A cavitating agent is added to the PE of the substrate layer 4, the cavitating agent being added to the substrate layer 4 in an amount of 5-30 wt. %, preferably 15-25 wt. %. A polymer that is incompatible with PE (i.e., a polymer that remains isolated in the PE matrix), for example polyamides (PA), polyesters (e.g., PET or PBT), polylactides (PLA), can be used as cavitating agents. A mineral cavitating agent such as calcium carbonate or mica can also be used. The cavitating agent is usually in the form of a fine powder, which is embedded as a masterbatch in a PE matrix and mixed with the PE granulate before it is extruded.

In order to achieve better printing and also better adhesion of the cavitated layer to the connecting layer 5, the substrate layer 4 can also have a multilayer structure. For this purpose, the cavitated PE layer is surrounded on one or both sides by a non-cavitated PE layer. A conceivable structure of the substrate layer 4 of the first laminate layer 3 would be, for example, a cavitated PE layer that is connected on one side to a non-cavitated PE layer (e.g., coextruded), the cavitated PE layer in the packaging laminate 1 facing the second laminate layer 3. Another preferred structure of the substrate layer 4 would be, for example, a cavitated PE layer, which is connected on both sides to a non-cavitated PE layer (for example coextruded). Such a structure of the substrate layer 4 can also improve the sealing properties of the packaging laminate 1.

The sum of polyethylene, cavitating agent, any additives, and possible compatible polyolefin materials in the substrate layer 4 can of course only add up to 100 wt. %. The decisive factor is the proportion of polyethylene upon which the other proportions must be based.

The barrier layer 6 consists of a barrier polymer, i.e., a polymer having a sufficient barrier property, in particular against oxygen, water and/or aroma. The barrier polymer is preferably a polyamide (PA) or an ethylene vinyl alcohol copolymer (EVOH). EVOH is preferred as the barrier polymer. The barrier layer 6 has a thickness of at most 20%, preferably 5 to 10%, of the overall thickness of the first laminate layer 2, i.e., a maximum of 2 to 8 μm. As a result of the low thickness of the barrier layer 6, recyclability is not impaired.

The connecting layer 5 is used to connect the barrier layer 6 and the substrate layer 4. In this embodiment, a sufficient bond strength has to be achieved, in particular in order to reliably prevent undesired delamination of the first laminate layer 2. Suitable connecting layers 5 preferably consist of polymers of increased polarity, for example based on polyolefins (such as PE or PP) modified with maleic anhydride, ethylene vinyl acetate copolymer (EVA), ethylene/acrylic acid copolymer (EAA), ethylene butyl acrylate copolymer (EBA), or similar polyolefin copolymers. The thickness of a connecting layer 5 is at most 10% of the overall thickness of the first laminate layer 2, typically 1 to 5 μm.

The second laminate layer 3 consists predominantly of a PE, wherein the PE proportion with respect to the total polymer amount of the second laminate layer 3, without any added mineral fillers or other fillers, should be at least 80 wt. %. Various PE types can be used, i.e., LDPE, LLDPE, MDPE, HDPE, in pure form or as a mixture, or in the form of copolymers or also in multiple layers. The thickness of the second laminate layer 3 is typically between 20 and 200 μm, depending on the application of the packaging laminate 1, and preferably forms a sealing layer in the packaging laminate 1.

A particularly advantageous embodiment of the present teaching consists in the use of a preferably 20 to 40 μm thin, coextruded and stretched PE layer, which is also cavitated in at least one layer, as the second laminate layer 3. A conceivable structure of the second laminate layer 3 would be, for example, a cavitated PE layer that is connected on one side to a non-cavitated PE layer (e.g., coextruded), the cavitated PE layer in the packaging laminate facing the first laminate layer 2. Another preferred structure of the second laminate layer would be, for example, a cavitated PE layer, which is connected on both sides to a non-cavitated PE layer (for example coextruded).

In the second laminate layer 3, too, the remainder will of course consist of PE or a compatible polyolefin material, as described above, in order to achieve the desired recyclability.

By using predominantly PE and compatible materials in the packaging laminate 1, a particularly recyclable laminate can be produced that can be easily and cost-effectively recycled using conventional methods in mechanical recycling, and has a very low density.

The first laminate layer 2 is produced by co-extrusion, because this provides for particularly simple, cost-effective production. Preferably, the known blown film or flat film extrusion process is used.

After co-extrusion, the first laminate layer 2 is stretched uni- or bidirectionally, i.e., in the machine direction (usually the longitudinal or extrusion direction) and/or in the transverse direction (rotated 90° with respect to the machine direction). The stretching ratio in the machine direction and in the transverse direction need not be the same. The stretching ratio in the machine direction is preferably at least 4:1 to 8:1. The stretching ratio in the transverse direction is preferably at least 5:1 to 10:1. The stretching can take place in-line (i.e., immediately after co-extrusion) or off-line (i.e., at a later point in time after co-extrusion). The stretching can take place in the machine direction first and then in the transverse direction, or it is also conceivable for the stretching to take place in both directions at the same time. The stretching typically takes place at approx. 10° C. to 30° C., typically approx. 20° C., below the lowest melting temperature (for HDPE, approx. 128° C. to 130° C.) in the first laminate layer 2.

It should be noted here that, with blown film extrusion and flat film extrusion, the extrusion gap (1.5 to 2.5 mm for blown film) or the gap of the extrusion die is significantly larger than the end thickness of the extruded film (typically between 10 and 200 μm). For this purpose, the extruded melt is elongated at temperatures well above the melting point of the extruded polymer, giving it its final thickness. In blown film extrusion, for example, the melt is typically elongated in the transverse direction by approx. a factor of 2 to 3 (what is referred to as the blow-up ratio) and in the longitudinal direction by a factor of 1:10 to 1:100 (what is referred to as the drawdown ratio). However, this elongation during extrusion cannot be compared to stretching a plastics film, since stretching is usually carried out at temperatures just below the melting point of the polymer, in order to permanently align the disordered polymers and the partially crystalline regions by stretching in the stretching direction.

As a result of the unidirectional or bidirectional stretching, microcavities are created in a known manner due to the cavitating agent in the PE of the substrate layer 4 of the first laminate layer 2. It was found that the density of the substrate layer 4 could be significantly reduced by the microcavities, to values between 0.4-0.85 g/cm³. The first laminate layer 2 thus becomes lighter. Of course, the same applies analogously to the second laminate layer 3 if it contains a cavitated polyethylene.

An asymmetrical structure of the stretched, first laminate layer 2 consisting primarily of polyethylene (in particular PE, EVOH) is untypical and has so far been avoided in practice, in particular with blown film, since it had been assumed that such a structure would curl, in particular due to water absorption of the polar barrier layer 6 lying on the outside in the first laminate layer 2, which would make further processing more difficult or impossible. It has been shown, however, that, with the specific design of the structure, curling occurs to an acceptable degree that does not hinder further processing. To this end, it is advantageous for the first laminate layer 2 to be connected to the second laminate layer 3 very soon after production in order to above all reduce the water absorption of the barrier layer 6. In certain circumstances, it may also be necessary or expedient to protect the co-extruded film roll comprising the first laminate layer 2 from water absorption by means of suitable packaging to until lamination.

The main advantage of the untypical asymmetrical structure of the first laminate layer 2 is, however, that only a single expensive and not very rigid connecting layer 5 is required. The costs for the first laminate layer 2 can thus be reduced and a more rigid first laminate layer 2 can be achieved. The higher rigidity is particularly advantageous when the packaging laminate 1 is used to produce a sachet (or the like).

By stretching the barrier layer 6, also approximately three to four times higher barrier values are achieved by comparison with an unstretched barrier polymer of the same type, and therefore a less expensive barrier polymer can be used with the same barrier effect. This can significantly reduce the cost of the first laminate layer 2. In addition, less barrier polymer is required for the same barrier effect, which also improves recyclability.

The first laminate layer 2 is preferably produced using the multistage blown film extrusion process (e.g., triple or double bubble process), because this results in fewer edge trimmings resulting from production, which leads to lower costs for the packaging laminate 1, especially with the more expensive barrier polymers comprised in the laminate. In blown film extrusion, more viscous HDPE materials having an MFI (mass flow index) of less than 3 can also be used. Such HDPE materials have a higher molecular weight and improved mechanical properties, which is favorable for use in a packaging laminate 1. However, such a material would tear particularly easily in the longitudinal direction and even lead to undesired splicing in the longitudinal direction. This undesirable property can be eliminated by integrating the HDPE material having an MFI of less than 3 in a first laminate layer 2, as described, and uniform tearing in both directions can even be achieved.

To produce the packaging laminate 1, the stretched first laminate layer 2 and the second laminate layer 3 are interconnected, preferably by extrusion lamination, extrusion coating, or adhesive lamination, whereas the second laminate layer 3 is connected to the barrier layer 6 of the first laminate layer 2. In extrusion coating, the second laminate layer 3 is extruded onto the barrier layer 6 of the first laminate layer 2, preferably also with an adhesion promoter therebetween. In lamination, the second laminate layer 3 is connected to the barrier layer 6 by means of a suitable laminating adhesive, for example based on polyurethane adhesives or polyolefin copolymers for extrusion lamination. The thickness of the laminating adhesive is preferably 2 to 5 g/m² for conventional adhesives based on polyurethane or 5 to 20 g/m² for extrusion lamination.

For this purpose, the barrier layer 6 can also be surface treated, for example by a corona or flame treatment, in order to improve the adhesive properties.

The second laminate layer 3 preferably forms a sealing layer 7 which, in packaging made from the packaging laminate 1, usually faces the packaged product. The packaging is to produced by cutting, folding, and heat sealing the packaging laminate 1, sealing layer against sealing layer or sealing layer against another packaging part. Possible forms of packaging are sachets, bags, pouches, etc.

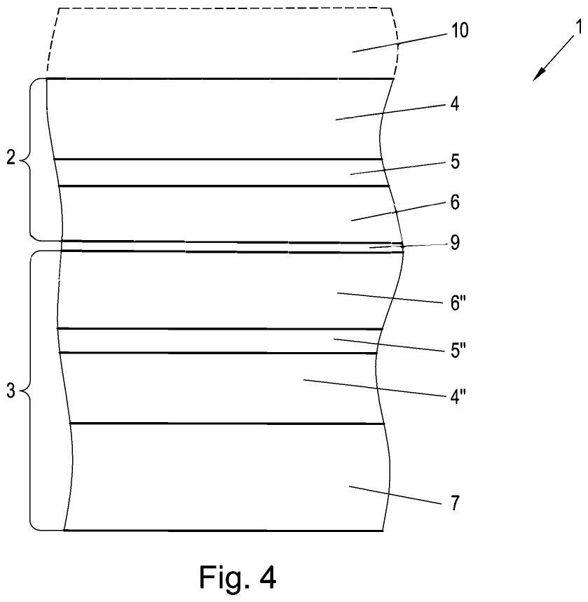

The second laminate layer 3 can also have a multilayer structure, for example extruded or co-extruded, as indicated in FIG. 2 and described in detail below. However, the second laminate layer 3 can also be provided with a barrier function and can also be stretched, as indicated in FIG. 4 and described in detail below.

In a further embodiment of the packaging laminate 1, as shown in FIG. 2, the first laminate layer 2 is connected on the side of the barrier layer 6 to the second laminate layer 3 and on the side of the substrate layer 4 to a further laminate layer 10, in this case a third laminate layer 8. The third laminate layer 8 is preferably a single- or multilayer polymer film, for example a film consisting predominantly of PE (at least 80 wt. % PE), as described with reference to the second laminate layer 3. The third laminate layer 8 can again either be extrusion-coated or adhesively laminated onto the first laminate layer 2, as explained with reference to the sealing layer 7 in FIG. 1. Such a packaging laminate 1 according to FIG. 2 can be used, for example, to produce tubes. In this case, the thickness of the second laminate layer 3 and the third laminate layer 8 is typically in the range of 150 μm.

It is also indicated in FIG. 2 that the second laminate layer 3 can also have a multilayer structure, in this case for example with two layers 7a, 7b which form the sealing layer 7, for example also with a layer of a cavitated polyethylene as described above. The same applies to the third laminate layer 8. Such a structure of the second laminate layer 3 can of course also be provided in an embodiment according to FIG. 1.

It is also possible to metallize and/or coat (for example with aluminum oxide or silicon oxide) the stretched first laminate layer 2 on the barrier layer 6 after stretching and before connecting the first laminate layer 2 to the second laminate layer 3. Metallization with aluminum is preferred. The barrier layer 6 can also be subjected to a pretreatment, for example a corona or flame treatment, for the purpose of coating or in order to increase the adhesion to the second laminate layer 3. However, the substrate layer 4 can also be printed or coated on the side lying on the outside in the packaging laminate 1, if necessary again after a surface treatment. In this embodiment, common printing processes can be used for this, for example gravure printing or flexographic printing.

The third laminate layer 8 could also be printed, metallized, or coated on one or both sides, in addition to or as an alternative to the printing, metallization, or coating of the first laminate layer 2.

In an advantageous design of the embodiment in FIG. 2, the barrier layer 6 of the first laminate layer 2 is metallized, preferably with aluminum, in order to increase the barrier effect. In addition, the third laminate layer 8 could be printed on the outside, or in reverse printing also on the opposite side.

FIG. 3 shows a further embodiment of a packaging laminate 1 according to the present teaching, which can preferably be used to produce tubes. In this embodiment, the first laminate layer 2 is connected, at the barrier layer 6, to the second laminate layer 3, as in the example from FIG. 1. The first laminate layer 2 is connected, at its substrate layer 4, to a further laminate layer 10, in this case a stretched fourth laminate layer 2′, which has the same structure as the first laminate layer 2. The fourth laminate layer 2′ thus in turn comprises a substrate layer 4′ which is connected to a barrier layer 6′ by a connecting layer 5′. In this embodiment, the barrier layer 6′ of the fourth laminate layer 2′ is connected to the substrate layer 4 of the first laminate layer 2, preferably by means of a suitable laminating adhesive as described above. These layers of the fourth laminate layer 2′ are structured and assembled as already described above. However, the substrate layer 4′ of the fourth laminate layer 2′ does not necessarily have to be provided with a cavitating agent in this embodiment. The fourth laminate layer 2′ consists primarily of PE materials having a PE proportion of at least 80 wt. %. The thicknesses and the exact compositions or materials of the individual layers of the first laminate layer 2 and the fourth laminate layer 2′ do not, however, have to be the same.

In this embodiment too, the fourth laminate layer 2′ can be printed, metallized, or coated on the substrate layer 4′ and/or on the barrier layer 6′, in addition to or as an alternative to the printing, metallization, or coating of the first laminate layer 2. In a particularly advantageous embodiment, the fourth laminate layer 2′ is printed, preferably on its barrier layer 6′, and the first laminate layer 2 is metallized, preferably on its barrier layer 6 or substrate layer 4. The barrier effect of the packaging laminate 1 can thus be increased. However, a coating of aluminum oxide or silicon oxide can also be provided on the barrier layer 6 or substrate layer 4 of the first laminate layer 2 in order to further increase the barrier effect.

FIG. 4 shows another advantageous embodiment of the present teaching. In this embodiment, the second laminate layer 3 again has a multilayer design and comprises a substrate layer 4″, a barrier layer 6″, and a connecting layer 5″, as with the first laminate layer 2. For these layers and also for the production of the second laminate layer 3, in this embodiment, the information given above in relation to FIGS. 1 to 3 for the first laminate layer 2 or fourth laminate layer 2′ applies analogously. However, the substrate layer 4″ does not necessarily have to be provided with a cavitating agent in this embodiment. In addition, the second laminate layer 3 comprises a sealing layer 7 in this embodiment. The sealing layer 7 preferably consists of a PE material such as mLLDPE, LLDPE, or another suitable thermoplastic, such as polypropylene (PP). However, this second laminate layer 3 having the sealing layer 7 still consists of at least 80 wt. % PE. The sealing layer 7 of the second laminate layer 3 is co-extruded with the other layers of the second laminate layer 3. The second laminate layer 3 in FIG. 4 is stretched, like the first laminate layer 2 and as described above. In this embodiment, the sealing layer 7 is therefore integrated in a multilayer stretched barrier film which has a similar structure to the first laminate layer 2.

In this embodiment, the stretched first laminate layer 2 and the stretched second laminate layer 3 are interconnected at the abutting barrier layers 6, 6″, preferably by adhesive lamination by means of an adhesive layer 9. A suitable laminating adhesive is, for example, an adhesive based on polyurethane or a polyolefin copolymer. The thickness of the lamination layer 9 is preferably 2 to 5 g/m².

In this embodiment, too, one (or more) of the layers of the packaging laminate 1 can be printed, metallized, or coated.

Of course, in this embodiment, a further laminate layer 10 (for example a third laminate layer 8 or fourth laminate layer 2′ as described above) could also be provided on the first laminate layer 2, as indicated in FIG. 4.

The packaging laminate 1 according to the present teaching thus has at least an asymmetrical, stretched first laminate layer 2 consisting of at least 60 wt. % PE and comprising a substrate layer 4 having a cavitating agent, a barrier layer 6, and a connecting layer 5, and a second laminate layer 3 which is connected to said first laminate layer and has a PE proportion of at least 80 wt. %. As described above, a further single- or multilayer laminate layer 10 (e.g., a third laminate layer 8 or fourth laminate layer 2′) having a PE proportion of at least 80 wt. % can be arranged on this packaging laminate 1 on the side of the first laminate layer 2 that faces away from the second laminate layer 3. This further single- or multilayer laminate layer 10 is thus connected to the substrate layer 4 of the first laminate layer 2.

In packaging made from a packaging laminate 1 according to the present teaching, the sealing layer 7 of the packaging laminate 1 advantageously faces the inside of the packaging.

By printing on at least one layer of the first laminate layer 2, the second laminate layer 3 or the further laminate layer 10 of a packaging laminate 1 according to the present teaching with a barrier varnish, for example polyvinyl alcohol (PVOH), the barrier effect of the packaging laminate 1 can also be further increased. Such varnish layers can be applied very thinly, typically in the range of 0.5 to 2.0 g/m², and thus do not impair the recyclability of the packaging laminate 1.

Finally, it should be noted that each of the above-described individual layers in the first laminate layer 2, the second laminate layer 3, or the further laminate layer 10 can themselves also have a multilayer structure.

It should also be noted that the second laminate layer 3 of the packaging laminate 1 does not necessarily have to form the sealing layer of the packaging laminate 1. In the same way, the substrate layer 4 of the first laminate layer 2 or a further laminate layer 10 could also form the sealing layer and the second laminate layer 3 could form the outside of the packaging laminate 1.

A possible advantageous structure of a packaging laminate 1 comprises a first stretched laminate layer 2 and a second stretched laminate layer 3. The first laminate layer 2 consists of an at least three-layer substrate layer 4, which has at least one central cavitated PE layer (preferably HDPE or MDPE or a mixture thereof), which is surrounded on each side by at least one non-cavitated PE layer (preferably HDPE or MDPE or a mixture thereof). This substrate layer 4 is connected to the barrier layer 6 by the connecting layer 5. The barrier layer 6 can also be metallized (for example aluminum) or coated (for example aluminum oxide or silicon oxide). The second laminate layer 3 has at least three layers, having a central cavitated PE layer (preferably HDPE or MDPE or a mixture thereof), which is surrounded on each side by at least one non-cavitated PE layer (preferably HDPE or MDPE or a mixture thereof). The first laminate layer 2 and the second laminate layer 3 are connected to one another by lamination with a laminating agent. If the substrate layer 4 of the first laminate layer 2 is used as a sealing layer, then the outside of the second laminate layer 3 can be printed. If the sealing layer is formed by the second laminate layer 3, then the substrate layer 4 can be printed.

1-17. (canceled)

18. A method for producing a packaging laminate comprising:
co-extruding a first laminate layer consisting of a substrate layer made of at least 60 wt. % polyethylene and 5 to 30 wt. % cavitating agent, a connecting layer and a barrier layer consisting of a barrier polymer having a thickness of at most 20% of the overall thickness of the first laminate layer, wherein the connecting layer is arranged between the substrate layer and the barrier layer and the substrate layer has a multilayer structure with a polyethylene layer cavitated with a cavitating agent, which is either connected on one side to a non-cavitated polyethylene layer, whereas the cavitated polyethylene layer faces the second laminate layer, or is connected on both sides to a non-cavitated polyethylene layer,
stretching the co-extruded first laminate layer,
co-extruding a second laminate layer having a polyethylene proportion of at least 80 wt. %, wherein the second laminate layer has a multilayer structure with a cavitated polyethylene layer which is either connected on one side to a non-cavitated polyethylene layer, whereas the cavitated polyethylene layer faces the first laminate layer, or is connected on both sides to a non-cavitated polyethylene layer,
stretching the co-extruded second laminate layer,
connecting the stretched first laminate layer to the stretched second laminate layer, wherein the second laminate layer is connected to the barrier layer of the first laminate layer.

19. The method according to claim 18, wherein the first laminate layer is metallized or coated on the barrier layer before being connected to the second laminate layer.

20. A packaging laminate comprising:
a first laminate layer and
a second laminate layer,
wherein the first laminate layer is a co-extruded and stretched composite consisting of a substrate layer having an PE proportion of at least 60 vol. %, a connecting layer and a barrier layer consisting of a barrier polymer having a thickness of at most 20% of the overall thickness of the first laminate layer, and
the second laminate layer contains at least 80 wt. % of PE,
wherein the connecting layer is arranged between the substrate layer and the barrier layer, and the first laminate layer is connected, at its barrier layer, to the second laminate layer,
wherein the substrate layer is a cavitated substrate layer with 5 to 30 wt. %, of cavitating agent and has a multilayer structure having a PE layer cavitated with a cavitating agent, which is either connected on one side to a non-cavitated polyethylene layer, whereas the cavitated PE layer faces the second laminate layer, or is connected on both sides to a non-cavitated PE layer and in that the second laminate layer has a multilayer structure having a cavitated PE layer which is either connected on one side to a non-cavitated polyethylene layer, whereas the cavitated PE layer faces the first laminate layer, or is connected on both sides to a non-cavitated PE layer.

21. The packaging laminate according to claim 20, wherein the barrier layer of the first laminate layer is metallized or coated.

22. The packaging laminate according to claim 20, wherein the second laminate layer or the substrate layer of the first laminate layer, or a further laminate layer connected to the first laminate layer forms a sealing layer of the packaging laminate.
